(19) United States
(12) Patent Application Publication
(10) Pub. No.: US 2011/0187678 A1
(43) Pub. Date: Aug. 4, 2011

(54) TOUCH SYSTEM USING OPTICAL COMPONENTS TO IMAGE MULTIPLE FIELDS OF VIEW ON AN IMAGE SENSOR

(75) Inventors: RICARDO R. SALAVERRY, SAN JOSE, CA (US); RAYMOND T. HEBERT, FLORENCE, OR (US)

(73) Assignee: TYCO ELECTRONICS CORPORATION, Berwyn, PA (US)

(21) Appl. No.: 12/696,475

(22) Filed: Jan. 29, 2010

(51) Int. Cl. G06F 3/042

(52) U.S. Cl. 345/175

(57) ABSTRACT

A touch system includes a touch sensing plane and a camera assembly that is positioned proximate the touch sensing plane. The camera assembly includes an image sensor and at least one virtual camera that has at least two fields of view associated with the touch sensing plane. The at least one virtual camera includes optical components that direct light that is proximate the touch sensing plane along at least one light path. The optical components direct and focus the light onto different areas of the image sensor.

### BACKGROUND OF THE INVENTION

Touch screen systems are available that use two or more camera assemblies that are located in different corners of the touch screen. Each of the camera assemblies includes one linear light sensor and simple optics such as a lens that detects light within a single field of view. One or more infrared light sources may be mounted in proximity to the lens or proximate other areas of the touch screen.

A touch screen system that uses one such camera assembly mounted in one corner of the touch screen and a second such camera assembly mounted in an adjacent corner of the touch screen provides reliable detection of a single touch on the touch screen using triangulation. The detection of the finger or stylus on the touch screen is made by detecting infrared light reflected by the stylus or finger, or by detecting a shadow of the stylus or finger due to the relative lack of light reflected from the bezel of the touch screen. However, some blind spots may occur near each of the camera assemblies where a location of a touch may not be determined.

Touch screen systems capable of detecting two or more simultaneous touches are desirable to increase the functionality for the user. Additional camera assemblies with linear image sensors located in other corners of the touch screen are needed to eliminate the aforementioned blind spots as well as to detect two or more simultaneous touches. Precise mechanical positioning of the multiple separate camera assemblies is needed, adding to the complexity of the system.

### BRIEF DESCRIPTION OF THE INVENTION

In accordance with an embodiment, a touch system includes a touch sensing plane and a camera assembly that is positioned proximate the touch sensing plane. The camera assembly includes an image sensor and at least one virtual camera that has at least two fields of view associated with the touch sensing plane. The at least one virtual camera includes optical components that direct light that is proximate the touch sensing plane along at least one light path. The optical components direct and focus the light onto different areas of the image sensor.

In accordance with an embodiment, a touch system includes a touch sensing plane and a camera assembly positioned proximate the touch sensing plane. The camera assembly includes an image sensor to detect light levels associated with light within the touch sensing plane. The light levels are configured to be used in determining coordinate locations in at least two dimensions of one touch or simultaneous touches within the touch sensing plane.

In accordance with an embodiment, a camera assembly for detecting one touch or simultaneous touches includes an image sensor and optical components that direct light associated with at least two fields of view along at least one light path. The optical components direct and focus the light that is associated with one of the fields of view onto one area of the image sensor and direct and focus the light that is associated with another one of the fields of view onto a different area of the image sensor. Light levels associated with the light are configured to be used in determining coordinate locations of one touch or simultaneous touches within at least one of the at least two fields of view.

### BRIEF DESCRIPTION OF THE DRAWINGS

FIG. 1A illustrates a touch system formed in accordance with an embodiment of the present invention that uses an image sensor.

FIG. 1B illustrates a touch sensing plane formed in accordance with an embodiment of the present invention that is positioned proximate the touch surface of the system of FIG. 1A.

FIG. 2 illustrates the camera assembly of FIG. 1A mounted in a corner of the display screen in accordance with an embodiment of the present invention.

FIG. 3 illustrates portions of the fields of view of the virtual cameras of the camera assembly of FIG. 1A in accordance with an embodiment of the present invention.

FIG. 4A illustrates the sensor surface of a two-dimensional image sensor that may be used in the camera assembly in accordance with an embodiment of the present invention.

FIGS. 4B and 4C illustrate the sensor surface of two different linear sensors that may be used in the camera assembly in accordance with an embodiment of the present invention.

FIGS. 5A and 5B illustrate two different views of a model of the camera assembly in accordance with an embodiment of the present invention.

FIG. 6 illustrates a curve that indicates a level of light detected by pixels on the sensor surface of the image sensor in accordance with an embodiment of the present invention.

FIG. 7 illustrates a touch system formed in accordance with an embodiment of the present invention that includes two camera assemblies that are mounted proximate different corners of the touch surface or touch sensing plane.

FIG. 8 illustrates a touch system having multiple camera assemblies and/or a camera having video capability mounted proximate the touch screen in accordance with an embodiment of the present invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

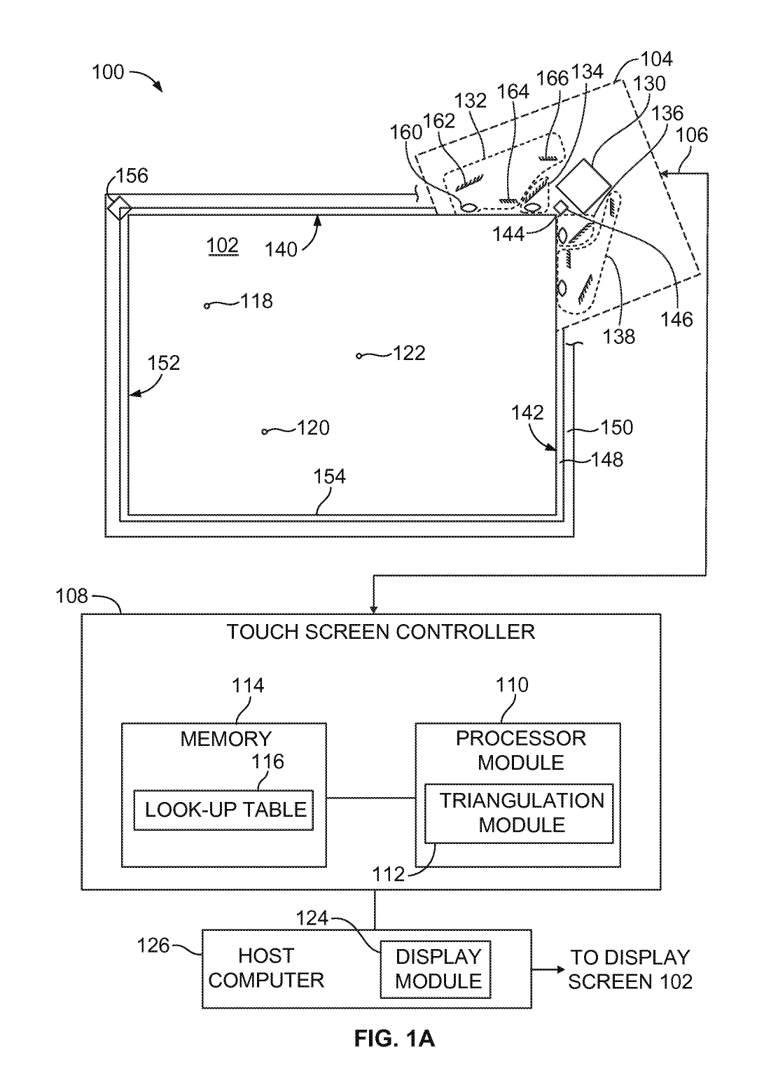

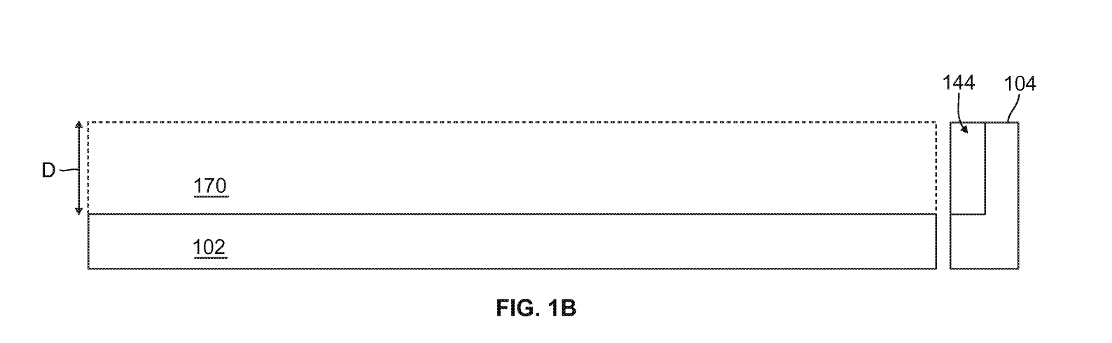

FIG. 1A illustrates a touch system 100. The touch system 100 may have a touch surface 102 that may be a sheet of glass, plastic, a flat panel display, a window or other transparent material that is placed in front of another display screen or objects of interest, and the like. The touch surface 102, or other display behind the touch surface 102, may display a graphical user interface (GUI) having virtual buttons and icons or other graphical representations. Therefore, in some embodiments the touch surface 102 may be a display screen but is not so limited. In other embodiments, the touch surface 102 may be located physically separate from the displayed graphics, such as to function as a track pad. Although the touch surface 102 is shown as rectangular, it should be understood that other shapes may be used.

FIG. 1B illustrates a touch sensing plane 170 that is positioned proximate the touch surface 102. In other embodiments, the touch surface 102 may not be used. The touch sensing plane 170 may be an air-space illuminated by a sheet of light that has a depth D that may be measured outwards from the touch surface 102. The sheet of light may be infrared and thus not visible to a user. Different depths may be used. For example, in some applications it may be desirable to detect a distance a pointer is from the touch surface 102 as the pointer moves through the depth of the touch sensing plane 170. In some embodiments, a touch may be detected prior to the pointer contacting the touch surface 102. In other embodiments, the system 100 may detect a “touch” when a pointer is within a predetermined distance of the touch surface 102 or when the pointer is within the touch sensing plane 170. In another embodiment, the system 100 may initiate different responses based on a distance of the pointer from the touch surface 102 or the position of the pointer with respect to the depth D.

Referring to both FIGS. 1A and 1B, a camera assembly 104 is mounted proximate one corner 144 of the touch surface 102 or the touch sensing plane 170. In other embodiments, the camera assembly 104 may be mounted proximate a different corner or along a side of the touch sensing plane 170 or touch surface 102, such as in a central position between two corners. However, the position of a camera assembly along a side of the touch surface 102 or touch sensing plane 170 is not limited to a central position. In general, the camera assembly 104 detects light that is proximate the touch surface 102 or touch sensing plane 170 and transmits information on cable 106 regarding the detected light, such as light levels, to a touch screen controller 108. The touch screen controller 108 may provide some control signals and/or power to the camera assembly 104 over the cable 106. In another embodiment, the information detected by the camera assembly 104 may be transmitted to the touch screen controller 108 wirelessly.

The camera assembly 104 includes an image sensor 130 and at least one virtual camera. A virtual camera may also be referred to as an effective camera. In one embodiment, the image sensor 130 may be a two-dimensional (2D) image sensor that may be a sensor type that is used in a digital camera. In another embodiment, the image sensor 130 may be a linear sensor. In some embodiments, the linear sensor may have a length such that different areas may be used to detect light levels associated with different fields of view, as discussed further below. In the embodiment of FIG. 1A, four virtual cameras 132, 134, 136 and 138 are used to detect at least four different fields of view. The virtual cameras 132 and 134 are positioned along one side 140 of the touch surface 102 and/or touch sensing plane 170 proximate the corner 144 and the virtual cameras 136 and 138 are positioned along another side 142 of the touch surface 102 and/or touch sensing plane 170 proximate the corner 144. The virtual cameras 132-138 have optical axis that are displaced with respect to each other. A virtual camera includes optical components that direct light proximate the touch surface 102 that is associated with one or more predetermined fields of view of the touch surface 102 or touch sensing plane 170 onto one or more predetermined areas of the image sensor 130. The virtual camera may include optical components that have different fields of view but optical axis that are close to one another. The fields of view may be adjacent or may be partially overlapping. Each virtual camera may have one field of view or more than one field of view forming one effective field of view. If multiple fields of view form one effective field of view, the optical axis of the multiple fields of view may be close to each other.

In one embodiment, directing the light may include one or more of focusing, reflecting and refracting optical components. For example, the virtual camera 132 has optical components 160, 162, 164 and 166. The light proximate the touch surface 102 is directed by at least one optical component, such as the component 160, and directed by the optical components, such as the components 162, 164 and 166, along a light path that extends to the image sensor 130. The light is then directed to and focused onto the predetermined area of the image sensor 130. Therefore, each virtual camera 132-138 has optical components that direct the light from predetermined fields of view of the touch surface 102 along a light path associated with the virtual camera. The light from each light path is directed and focused onto a different predetermined area of the image sensor 130. In one embodiment, the alignment of the directed and focused light with respect to the area of the image sensor 130 may be accomplished through software in conjunction with, or rather than, mechanical alignment of structural components.

The camera assembly 104 may in some embodiments include a light source 146 that illuminates the touch sensing plane 170 with a sheet of light. The touch sensing plane 170 may be substantially parallel to the touch surface 102. The light source 146 may be an infrared light source, although other frequencies of light may be used. Therefore, the light source 146 may be a visible light source. In another embodiment, the light source 146 may be a laser diode such as a vertical-cavity surface emitting laser (VCSEL), which may provide a more refined fan beam compared to an alternative infrared light source. The light source 146 may provide constant illumination when the system 100 is active, or may provide pulses of light at common intervals. The light source 146 may illuminate the entirety or a portion of the touch sensing plane 170. In another embodiment, a second light source 156 may be mounted proximate a different corner or along a side of the touch surface 102 or touch sensing plane 170. Therefore, in some embodiments more than one light source may be used, and in other embodiments, the light source may be located away from the camera assembly 104.

In some embodiments, a reflector 148 is mounted proximate to the sides 140, 142, 152 and 154 of the touch surface 102. The reflector 148 may be formed of a retroreflective material or other reflective material, and may reflect the light from the light source 146 towards the camera assembly 104. The reflector 148 may be mounted on or integral with an inside edge of a bezel 150 or frame around the touch surface 102. For example, the reflector 148 may be a tape, paint or other coating substance that is applied to one or more surfaces of the bezel 150. In one embodiment, the reflector 148 may extend fully around all sides of the touch surface 102. In another embodiment, the reflector 148 may extend fully along some sides, such as along the sides 152 and 154 which are opposite the camera assembly 104 and partially along the sides 140 and 142, such as to not extend in the immediate vicinity of the camera assembly 104.

A processor module 110 may receive the signals sent to the touch screen controller 108 over the cable 106. Although shown separately, the touch screen controller 108 and the image sensor 130 may be within the same unit. A triangulation module 112 may process the signals to determine if the signals indicate no touch, one touch, or two or more simultaneous touches on the touch surface 102. For example, the level of light may be at a baseline profile when no touch is present. The system 100 may periodically update the baseline profile based on ambient light, such as to take into account changes in sunlight and room lighting. In one embodiment, if one or more touch is present, a decrease in light on at least one area of the sensor 130 may be detected. In another embodiment, the presence of one or more touch may be indicated by an increase in light on at least one area of the sensor 130. In one embodiment, the triangulation module 112 may also identify the associated coordinates of any detected touch. In some embodiments, the processor module 110 may also access a look-up table 116 or other storage format that may be stored in the memory 114. The look-up table 116 may be used to store coordinate information that is used to identify the locations of one or more touches. For example, (X, Y) coordinates may be identified. In another embodiment, (X, Y, Z) coordinates may be identified, wherein the Z axis provides an indication of how close an object, such as a finger or stylus, is to the touch surface 102 or where the object is within the depth of the touch sensing plane 170. Information with respect to how fast the object is moving may also be determined. The triangulation module 112 may thus identify one or more touches that are within a predetermined distance of the touch surface 102. Therefore, touches may be detected when in contact with the touch surface 102 and/or when immediately proximate to, but not in contact with, the touch surface 102. In some embodiments, the processing of signals to identify presence and coordinates of one or more touches may be accomplished in hardware, software and/or firmware that is not within the touch screen controller 108. For example, the processor module 110 and/or triangulation module 112 and/or processing functionality thereof may be within a host computer 126 or other computer or processor, or within the camera assembly 104.

As used herein, “simultaneous touches” refers to two or more touches that are present within the touch sensing plane 170 and/or in contact with the touch surface during a same time duration but are not necessarily synchronized. Therefore, one touch may have a duration that starts before the beginning of the duration of another touch, such as a second touch, and at least portions of the durations of the first and second touches overlap each other in time. For example, two or more simultaneous touches occur when objects such as a finger or stylus makes contact with the touch surface 102 in two or more distinct locations, such as at two or more of the locations 118, 120 and 122, over a same time duration. Similarly, two or more simultaneous touches may occur when objects are within a predetermined distance of, but not in contact with, the touch surface 102 in two or more distinct locations over a same time duration. In some embodiments, one touch may be in contact with the touch surface 102 while another simultaneous touch is proximate to, but not in contact with, the touch surface 102.

When one or more touches are identified, the processor module 110 may then pass the (X, Y) coordinates (or (X, Y, Z) coordinates) to a display module 124 that may be stored within one or more modules of firmware or software. The display module 124 may be a graphical user interface (GUI) module. In one embodiment, the display module 124 is run on a host computer 126 that also runs an application code of interest to the user. The display module 124 determines whether the coordinates indicate a selection of a button or icon displayed on the touch surface 102. If a button is selected, the host computer 126 or other component(s) (not shown) may take further action based on the functionality associated with the particular button. The display module 124 may also determine whether one or more touch is associated with a gesture, such as zoom or rotate. The one or more touch may also be used to replace mouse and/or other cursor input.

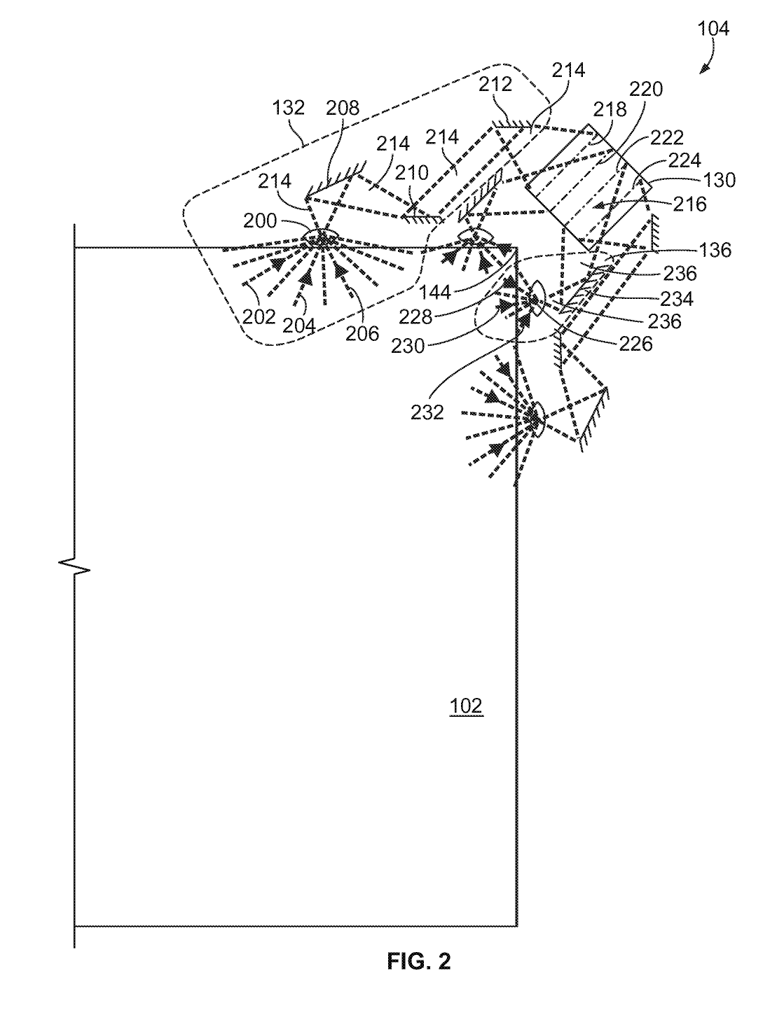

FIG. 2 illustrates the camera assembly 104 of FIG. 1A mounted in the corner 144 of the touch surface 102. The image sensor 130 may be a linear sensor or a two-dimensional (2D) image sensor. Within the virtual cameras, the optical components form a complex optical system. The optical components may have one optical surface or a plurality of optical surfaces. Each of the optical components may be formed of a single piece of material (such as by injection molding) or by more than one piece of material that has been joined, fused, or otherwise connected together to form one piece. By way of example, some of the optical surfaces may be reflector surfaces and some of the optical surfaces may be refractor surfaces. Therefore, an optical component may function similar to a lens or a prism, and thus may refract light, and/or may function similar to a mirror to reflect light. For example, with respect to the virtual camera 132, an optical component 200 may direct light similar to the functionality of a lens, wherein the light is indicated with arrows 202, 204 and 206. It should be understood that the optical component 200 directs light over a continuous angular field of view (FOV) and is not limited to the indicated arrows 202-206. The optical component 200 directs the light towards the next optical component 208 along light path 214. Similarly, the optical component 208 directs the light towards the optical component 210, which directs the light towards optical component 212. The optical component 212 then directs and focuses light onto a predetermined area on the image sensor 130. Therefore, in some embodiments directing light may include one or more of refracting, reflecting and focusing. The optical components 200, 208, 210 and 212 may each include one or more optical surface. In one embodiment, one or more of the optical components 200, 208, 210 and 212 may be a mirror, and thus have a single optical surface. In some embodiments, the light path 214 may also be referred to as a channel or optical relay. In other embodiments, a light path 214 or channel may be split into two or more light paths or sub-channels as discussed further below. It should be understood that more or fewer optical components having one or more optical surface each may be used.

The directed light is focused and/or directed on an area, such as area 218, 220, 222, or 224 of a sensor surface 216 of the image sensor 130. In one embodiment, the image sensor 130 may be a 2D image sensor and the sensor surface 216 may have a plurality of sensing lines that sense levels of light as shown in FIG. 2. The sensing lines may extend across the sensor surface 216 from one side to an opposite side and may be parallel to each other. By way of example only, the sensing lines may be one pixel in width and many pixels in length, such as at least 700 pixels in length. 2D image sensors may have a large number of sensing lines, such as 480 sensing lines in a VGA format. Therefore, the areas 218-224 may represent one sensing line apiece, wherein in some embodiments, the optical components may direct and focus the light onto four different sensing lines while in other embodiments, the light may be directed and focused onto a plurality of neighboring sensing lines, as discussed further below. In another embodiment, the 2D image sensor may provide a set of pixels that are grouped into configurations other than lines.

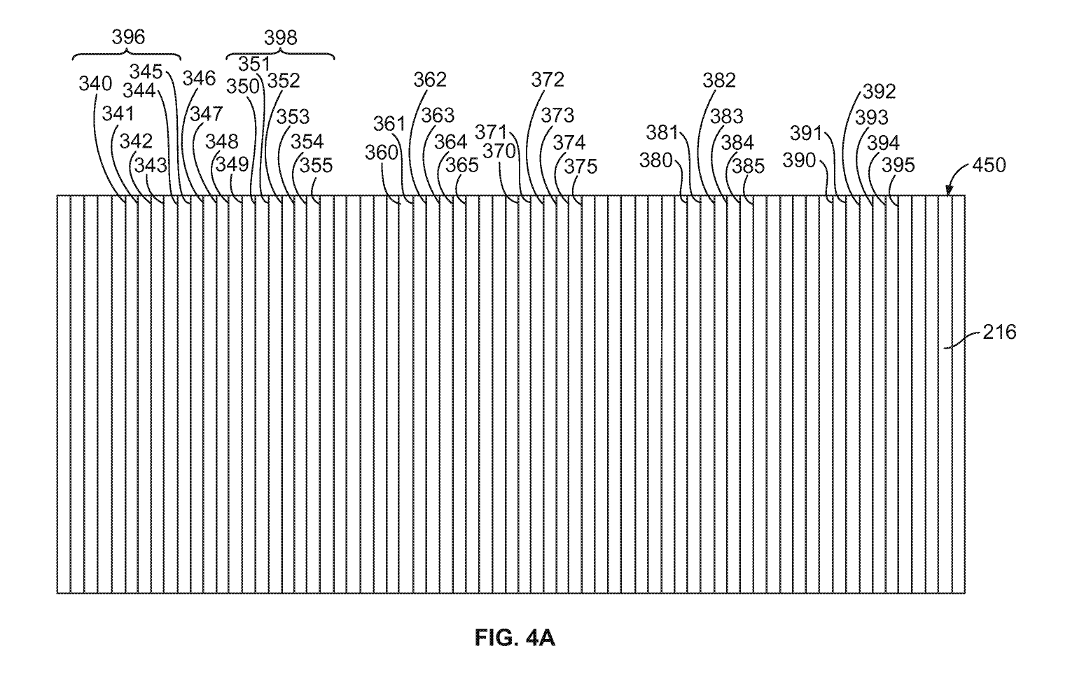

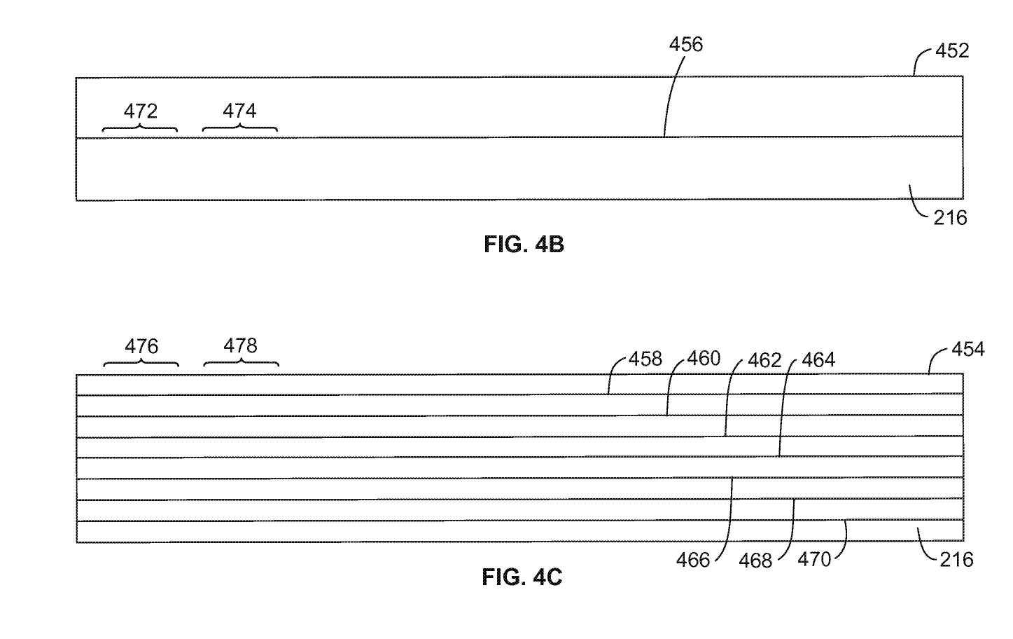

In another embodiment, if the image sensor 130 is a linear sensor, the sensor surface 216 may have a single sensing line that extends along a length of the linear sensor, as shown below in FIG. 4B. The sensing line may be many pixels in length. In yet another embodiment, the linear sensor may have a plurality of sensing lines that extend along a length of the linear sensor, as shown below in FIG. 4C. The areas 218-224 may then represent sets or predetermined numbers of pixels. The optical components may direct and focus the light onto groups of pixels along the single sensing line, or onto groups of pixels along the plurality of sensing lines.

Referring to the virtual camera 136 shown in FIG. 2, the optical components include optical component 226 that directs light that is indicated with arrows 228, 230 and 232. The optical component 226 directs the light toward optical component 234 along light path 236. The optical components 226 and 234 may each have one or more refractor surface and/or one or more reflector surface. The light path 236 may be shorter than the light path 214, and thus less optical components may be used. The light is directed and focused onto a different area of the sensor surface 216 of the image sensor 130. In one embodiment, the virtual cameras 132, 134, 136 and 138 may direct and focus the light onto areas and/or sensing line(s) of the sensor surface 216 that are separate with respect to each other.

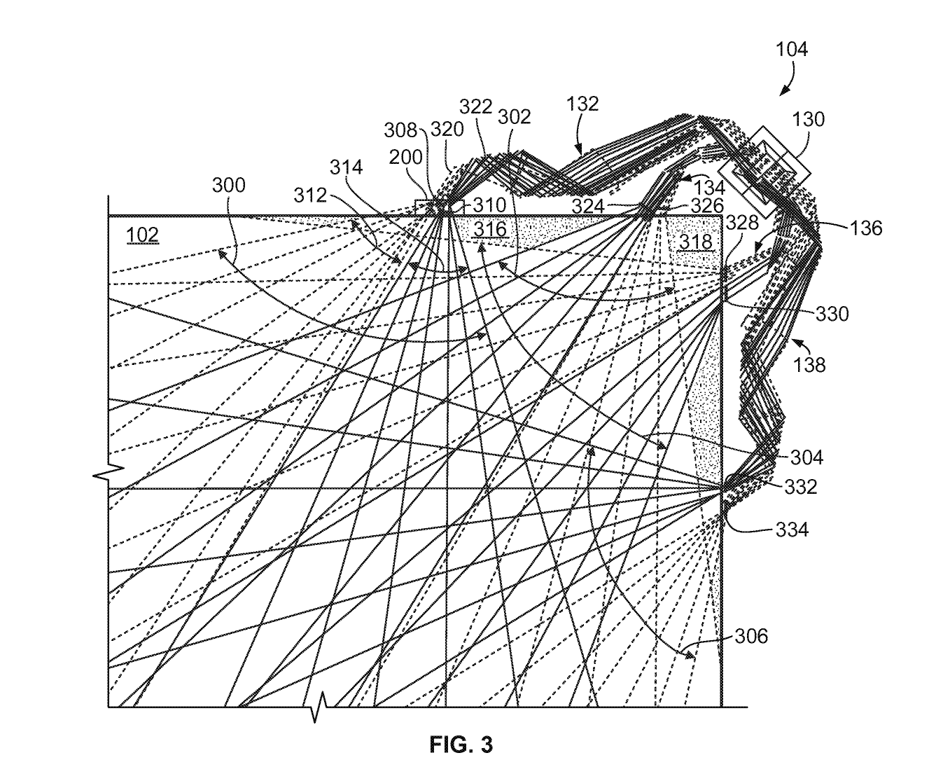

FIG. 3 illustrates portions of the fields of view of the virtual cameras 132-138 that may, in combination, detect at least two dimensions of the coordinate locations of one touch or simultaneous touches on the touch surface 102. For example, virtual camera 132 has FOV 300, virtual camera 134 has FOV 302, virtual camera 136 has FOV 304 and virtual camera 138 has FOV 306. The FOVs 300-306 may extend across the touch surface 102 to the bezel 150 on the opposite side. In one embodiment, the FOVs 300-306 may provide an angular coverage of approximately ninety degrees, although other angular coverages are contemplated. The FOVs 300-306 may also be referred to as angular segments, and may be divided into smaller angular segments. The FOVs 300-306 may be considered to be effective fields of view, wherein one or more of the FOVs 300-306 may be made up of more than one elemental FOV.

The FOV 300 overlaps at least portions of the fields of view 302, 304 and 306. In one embodiment, a FOV of a virtual camera may entirely overlap a FOV of another virtual camera. In another embodiment, a FOV of a first virtual camera may overlap some of the fields of view of other virtual cameras while not overlapping any portion of another FOV of a second virtual camera. In yet another embodiment, the FOVs of at least some of the virtual cameras may be adjacent with respect to each other.

In the embodiment shown in FIG. 3, the virtual cameras 132-138 may have two optical surfaces positioned proximate the touch surface 102 for directing light that is proximate to the touch surface 102 and/or touch sensing plane 170, wherein each of the optical surfaces directs light associated with at least a portion of the FOV of the associated virtual camera 132-138. For example, the virtual camera 132 has two optical surfaces 308 and 310 within the optical component 200. In another embodiment, the optical surfaces 308 and 310 may be formed within separate optical components. The optical surface 308 may have a FOV 312 and optical surface 310 may have a FOV 314. In one embodiment, the fields of view 312 and 314 may detect an angular coverage of approximately forty-five degrees. However, it should be understood that one optical surface may detect more than half of the overall FOV 300. Also, more than two optical surfaces positioned proximate the touch surface 102 may be used in a virtual camera, directing light from an equal number of fields of view within the overall FOV. In one embodiment the fields of view 312 and 314 may be at least partially overlapping. In another embodiment, the fields of view 312 and 314 may detect areas of the touch surface 102 or touch sensing plane 170 that are not overlapping. The fields of view of a virtual camera may be adjacent with respect to each other or at least some of the fields of view may be slightly overlapping. In some embodiments, having more than one elemental field of view within a virtual camera may provide broader angular coverage compared to a single field of view.

The two optical surfaces 308 and 310 of virtual camera 132 direct the light that is proximate the touch surface 102 and/or within the touch sensing plane 170. The optical surface 308 is associated with one light path 320 and the optical surface 310 is associated with another light path 322. The light paths 320 and 322 may be formed, however, by using the same set of optical components within the virtual camera 132, such as the optical components 200, 208, 210 and 212 shown in FIG. 2. The light paths 320 and 322 may be separate from each other. In some embodiments, the light paths 320 and 322 may be co-planar with respect to each other. The light paths 320 and 322 may be directed and focused to illuminate areas and/or line(s) of the sensor surface 216 that are different from each other but that are both associated with the virtual camera 132, or may illuminate one common area associated with virtual camera 132.

Although each of the virtual cameras 132-138 are shown as having two light paths in FIG. 3, it should be understood that one or more of the virtual cameras 132-138 may have one light path or have additional optical components to form more than two light paths.

One or more small dead zones, such as dead zones 316 and 318 may occur immediately proximate the camera assembly 104 on outer edges of the touch surface 102. In some embodiments, the bezel 150 (as shown in FIG. 1A) may extend over the touch surface 102 to an extent that covers the dead zones 316 and 318. In another embodiment, the GUI may be prohibited from placing any selectable icons in the dead zones 316 and 318. In yet another embodiment, a second camera assembly may be used in a different corner or along an edge of the touch surface 102 to cover the dead zones 316, 318 experienced by the camera assembly 104, as well as other areas of the touch surface 102.

FIG. 4A illustrates the sensor surface 216 of a 2D image sensor 450. Although not all of the sensing lines have been given item numbers, a plurality of sensing lines is shown across the sensor surface 216. In one embodiment, 480 or more sensing lines may be provided. As discussed previously, the sensing lines may include a plurality of pixels that sense the detected light.

In FIG. 2, the light associated with a light path is shown as being directed and focused onto a single sensing line. However, in some embodiments, the light of a light path may be directed and focused onto a plurality of adjacent or neighboring lines, which may improve resolution. For example, in one embodiment the light may be directed and focused onto four neighboring lines while in another embodiment the light may be directed and focused onto six or eight neighboring lines. It should be understood that more or less neighboring lines may be used, and that the light associated with different fields of view may be focused onto different numbers of neighboring lines.

Referring to both FIGS. 3 and 4A, the directed light associated with the optical surface 308 and the FOV 312 of the virtual camera 132 may be directed and focused onto an area of 2D image sensor 450 including sensing lines 340, 341, 342, 343, 344 and 345. The sensing lines 340 and 341 are neighboring lines, sensing lines 341 and 342 are neighboring lines, and so on. The directed light associated with the optical surface 310 and the FOV 314 of the virtual camera 132 may be directed and focused onto an area of 2D image sensor 450 including sensing lines 350, 351, 352, 353, 354, and 355. Again, the sensing lines 350 and 351 are neighboring lines, sensing lines 351 and 352 are neighboring lines, and so on. Therefore, the sensing lines 340-345 form a set of neighboring lines 396 and sensing line 350-355 form another separate set of neighboring lines 398. Sensing lines 345 and 350, however, are not neighboring lines. In one embodiment, at least one sensing line separates the sets of neighboring lines 396 and 398. In the embodiment shown, lines 346, 347, 348 and 349 separate the two sets of neighboring lines 396 and 398. In some embodiments, an increase in resolution may be achieved by directing and focusing the light from one virtual camera onto more than one set of sensing lines, such as by directing and focusing the light associated with the FOVs 312 and 314 of the virtual camera 132 onto different areas of the 2D image sensor 450.

Turning to the virtual camera 134, two optical components 324 and 326 direct light associated with the FOV 302. The light paths associated with the two optical components 324 and 326 may be directed and focused onto one set of sensing lines. For example, the directed light associated with the optical components 324 and 326 may be directed and focused onto an area including sensing lines 360, 361, 362, 363, 364 and 365. Again the set of sensing lines 360-365 may be separate from other sets of sensing lines.

Similarly, the virtual camera 136 may have two optical components 328 and 330 that direct light associated with the FOV 304. The directed light may be directed and focused onto the neighboring sensing lines 370, 371, 372, 373, 374 and 375. The virtual camera 138 may have two optical components 332 and 334 that direct light associated with the FOV 306. The directed light from the optical component 332 may be directed and focused onto the neighboring sensing lines 380, 381, 382, 383, 384 and 385, while the directed light from the optical component 334 may be directed and focused onto the neighboring sensing lines 390, 391, 392, 393, 394 and 395.

The optical components or optical surfaces of one virtual camera, such as virtual camera 134, may be displaced with respect to the optical components or surfaces of the other virtual cameras 132, 136 and 138 to provide binocular vision. In contrast, optical components or optical surfaces that are positioned close to one another, such as the optical surfaces 308 and 310, may be considered to be within the same virtual camera because the optical surfaces increase the effective angular FOV of the same virtual camera.

FIGS. 4B and 4C illustrate the sensor surface 216 of linear sensors 452 and 454, respectively. The linear sensor 452 has one sensing line 456, while the linear sensor 454 has multiple sensing lines 458, 460, 462, 464, 466, 468 and 470. The linear sensor 454 may also be referred to as a custom 2D sensor. Similar to FIG. 4A, the light associated with different fields of view may be focused onto different areas of the sensor surface 216. Referring to the linear sensor 452 of FIG. 4B, the directed light associated with the optical surface 308 and the FOV 312 of the virtual camera 132 may be directed and focused onto an area 472 of the sensing line 456 that may, for example, include a predetermined number of pixels. The directed light associated with the optical surface 310 and the FOV 314 of the virtual camera 132 may be directed and focused onto area 474 of the sensing line 456. Referring to the linear sensor 454 of FIG. 4C, the directed light associated with the optical surface 308 and the FOV 312 of the virtual camera 132 may be directed and focused onto area 476 of one or more of the sensing lines 458-470, thus including both a predetermined number of pixels and a predetermined number of sensing lines. The directed light associated with the optical surface 310 and the FOV 314 of the virtual camera 132 may be directed and focused onto area 478 of one or more of the sensing lines 458-470.

It should be understood that other sensor configurations may be used. Therefore, different sensing lines and pixel arrangements may be used while still providing the ability to focus light associated with different fields of view on different areas of the image sensor.

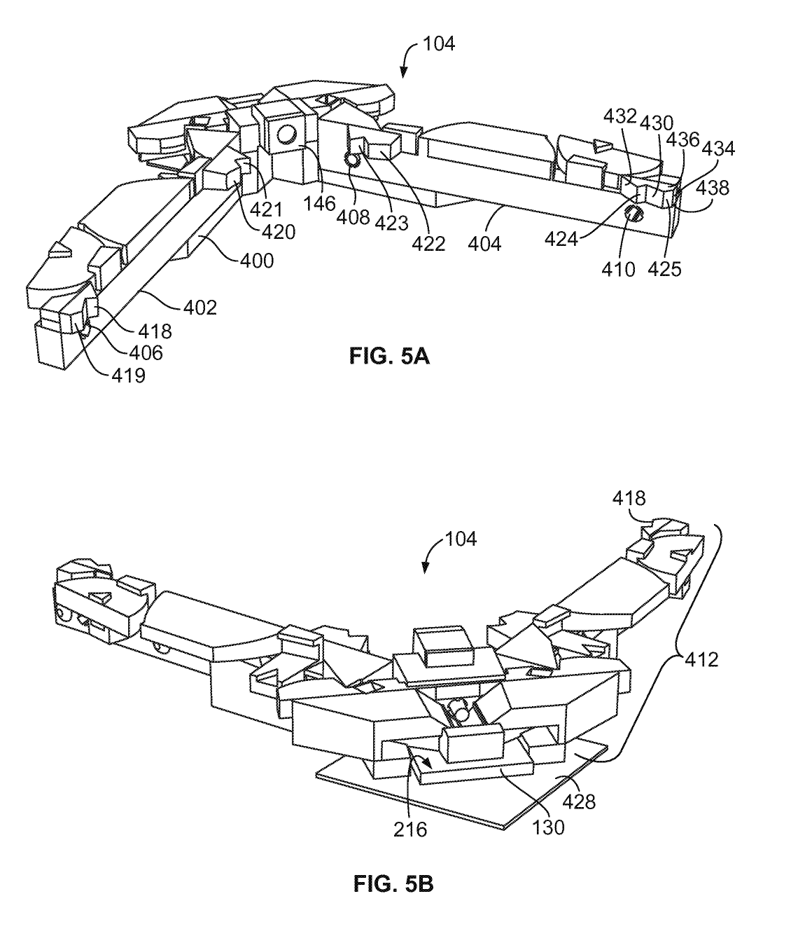

FIGS. 5A and 5B illustrate a model of the camera assembly 104. FIG. 5A shows a view of the camera assembly 104 as looking into the light source 146. FIG. 5B shows a view from the opposite side of the camera assembly 104 that looks at a portion of the image sensor 130. A base 400 may be used to position the optical components. In one embodiment, the optical components may be formed of a single piece of material, such as molded plastic. In another embodiment, portions of the optical components may be formed separately and then joined together. The optical components may be at least partially formed of at least one transparent material. Although not shown, a light shield and/or other opaque material may be used to cover at least portions of the optical components and the image sensor 130. The optical components associated with one virtual camera may thus be shielded from light contamination resulting from ambient light and/or other virtual cameras.

Structure 402 and 404 may be provided having one or more through holes 406, 408 and 410 for connecting the camera assembly 104 to other structure associated with the touch surface 102. The structure 402 and 404 may extend below the optical components. Other structural and attachment configurations are contemplated.

Optical surfaces 418 and 419 are associated with the virtual camera 132, optical surfaces 420 and 421 are associated with the virtual camera 134, optical surfaces 422 and 423 are associated with the virtual camera 136, and optical surfaces 424 and 425 are associated with the virtual camera 138. By way of example only, each of the optical surfaces 418 and 419 may be associated with a different optical component or may be formed integral with a single optical component. In one embodiment, one or more of the optical components associated with the virtual cameras 132, 134, 136 and 138 may have more than one optical surface.

As discussed above, some surfaces may be formed of an optically black or light occluding material, or may be covered with a light occluding material. For example, referring to the virtual camera 138 and the optical surfaces 424 and 425, surfaces 430, 432, 434, 436 and 438 (the surface closest to and substantially parallel with the touch surface 102 and/or the touch sensing plane 170), may be covered or coated with a light occluding material. Similarly, the outside surfaces of the material forming the optical components that direct the light paths to the image sensor 130 may be covered with a light occluding material. Surfaces that do not result in light interference may not be covered with a light occluding material.

Referring to FIG. 5B, the optical surface 418 of virtual camera 132 directs the light to optical components 412 that form the light path. The light is directed towards the image sensor 130, which may be mounted on a printed circuit board 428. When in the proximity of the sensor 130, optical components direct and focus the light downwards onto the sensor surface 216. It should be understood that the sensor 130 may be oriented in different positions; therefore the sensor surface 216 is not limited to being substantially co-planar with the touch surface 102. Although not shown, other components may be included on the printed circuit board 428, such as, but not limited to, a complex programmable logic device (CPLD) and microprocessor.

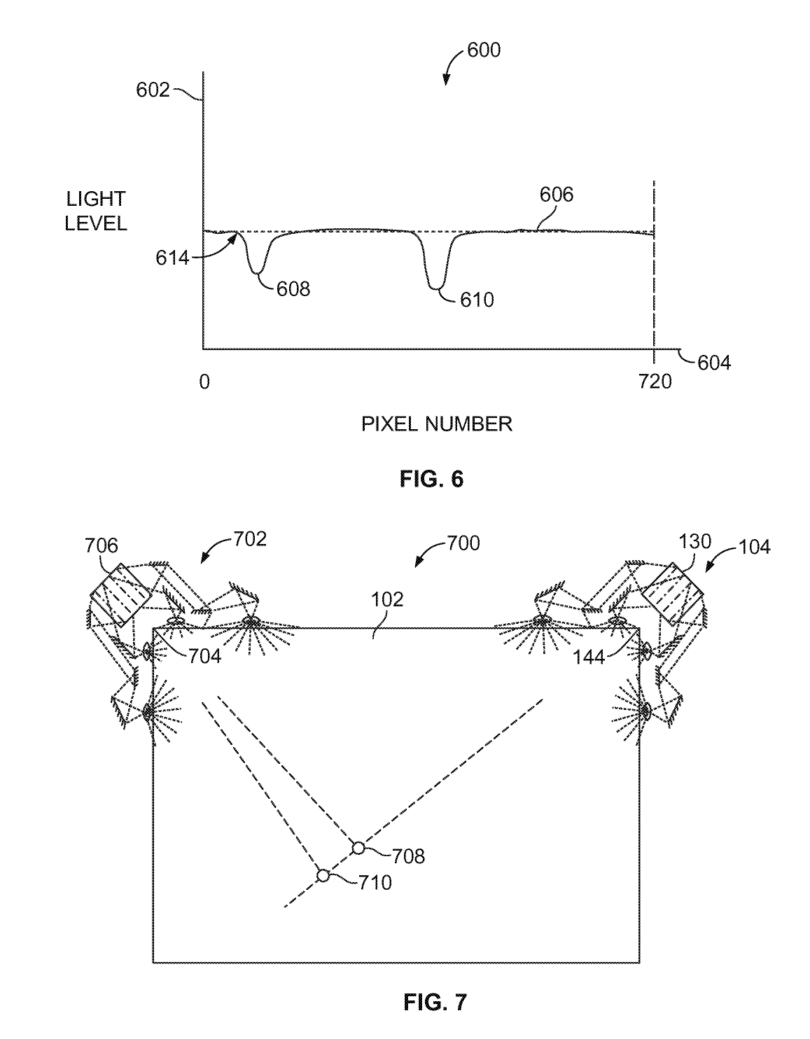

FIG. 6 illustrates a graph 600 of a curve 614 that indicates a level of light detected on the sensor surface 216 of the image sensor 130 on the vertical axis 602 and a corresponding pixel number of a given sensing line of the image sensor 130 on horizontal axis 604. By way of example, the horizontal axis 604 extends from zero pixels to 720 pixels, but other ranges may be used. A baseline profile 606 may be determined that indicates the light levels detected when no touch is present. In one embodiment the baseline profile 606 may be a range. Additionally, the baseline profile 606 may be updated constantly or at predetermined intervals to adjust for changes in ambient light levels. For example, the baseline profile may change based on environmental changes such as sunlight and room lighting. In one embodiment, when the light from a light path is directed and focused onto more than one neighboring sensing line, each of the neighboring sensing lines would have a curve that is associated with the same FOV. Therefore, if the light associated with FOV 312 is directed and focused onto sensing lines 340-345, each of the sensing lines may have a curve associated with the FOV 312.

A dip may be indicated in the graph 600 when a touch is present. More than one dip 608 and 610 is indicated when more than one touch is present within the associated FOV. This may occur because the finger, stylus or other selecting item may block the return of reflected light to the virtual camera. In other embodiments wherein an increase in detected light is used to detect a touch, an upward protrusion above the baseline profile 606 in the graph 600 occurs rather than a dip. Therefore, the detection of one or more touch may be determined based on an increase in detected light. This may occur in touch systems that do not use the reflector 148 shown in the system of FIG. 1A. In some embodiments wherein multiple neighboring sensing lines are associated with a FOV, the dip having the greatest displacement with respect to the baseline profile 606 or a predetermined desired shape or minimum level of displacement with respect to the baseline profile 606 may be used to identify the coordinates of the touch.

A portion of the pixels in the image sensor 130 may individually or in sets be associated with an angle with respect to the optical component and/or optical surface(s) of the optical component of the particular virtual camera. For the detection of a single touch, triangulation may be accomplished by drawing lines from the optical surfaces at the specified angles, indicating the location of the touch where the lines cross. More rigorous detection algorithms may be used to detect two or more simultaneous touches. In some embodiments, the look-up table 116 may be used alone or in addition to other algorithms to identify the touch locations.

In some embodiments, a centroid of the touch may be determined. For example, the use of the reflector 148 may improve the centroid determination as the reflector 148 creates an intense return from the light source 146, creating a bright video background within which the touch appears as a well defined shadow. In other words, a strong positive return signal is detected when a touch is not present and a reduction in the return signal is detected when a touch is present.

In some embodiments, the pointer that is used to select a touch location may contribute a positive signal that is somewhat variable depending on pointer color, reflectivity, texture, shape and the like, and may be more difficult to define in terms of its associated centroid. In a touch system having a light source 146 and reflector 148, the pointer blocks the strong positive return signal from the reflector 148. The drop in the return signal may be very large in contrast to the positive signal from the pointer, rendering the reflective effect of the pointer as a net reduction in signal which may not negatively impact the ability of the system 100 to detect the coordinates of the touch.

FIG. 7 illustrates a touch system 700 that includes the camera assembly 104 mounted proximate the corner 144 as shown in FIG. 1A and a second camera assembly 702 mounted proximate corner 704 of the touch surface 102 and/or touch sensing plane 170. The second camera assembly 702 includes another image sensor 706 (which may be a 2D image sensor or a linear sensor) and optical components as previously discussed. The corners 144 and 704 may be adjacent with respect to each other although are not so limited.

The additional camera assembly 702 may be used for more robust touch detection and/or to identify an increasing number of simultaneous touches. For example, a single camera assembly may not be able to detect two simultaneous touches when the touches are close to each other and far away from the camera assembly, or when the camera assembly and the two touches are substantially in line with respect to each other. Referring to FIG. 7, a touch at location 708 may be detected by the camera assembly 104 but may also obscure touch at location 710. The camera assembly 702, however, may accurately detect both of the touches at locations 708 and 710.

The additional camera assembly 702 may also be used if the touch surface 102 and/or touch sensing plane 170 are relatively large and/or more than one user may interact with the touch surface 102 at the same time. The information detected by the camera assemblies 104 and 702 may be combined and used together to identify locations of touches, or may be used separately to identify locations of touches. The fields of view of the virtual cameras within the camera assembly 702 may at least partially overlap at least some of the fields of view discussed in FIG. 3 with respect to the camera assembly 104. However, in some embodiments at least one of the camera assemblies 104 and 702 may have at least one FOV that is not shared by the other camera assembly.

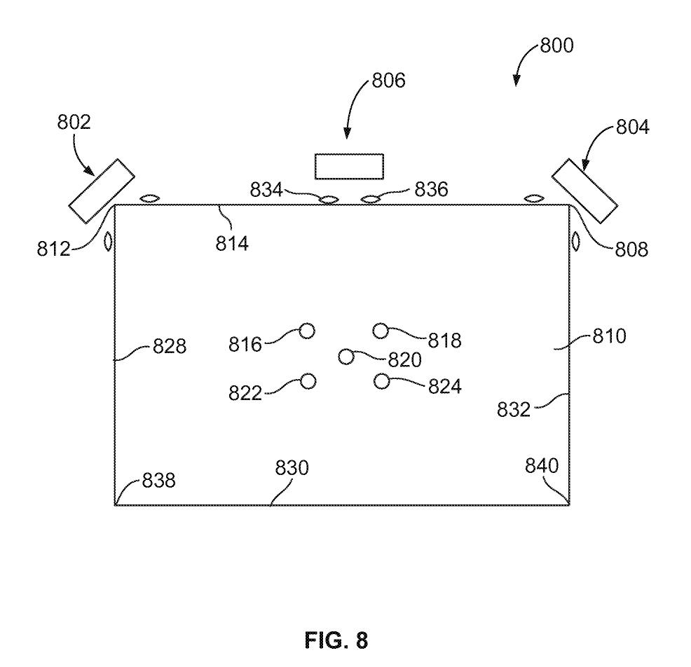

FIG. 8 illustrates a touch system 800 having camera assembly 804 mounted proximate one corner 808 of a touch screen 810, camera assembly 802 mounted proximate a different corner 812 of the touch screen 810, and camera assembly 806 mounted proximate a side 814 of the touch screen 810. Although shown approximately centered between the camera assemblies 802 and 804, the camera assembly 806 may be mounted anywhere along the side 814 or proximate another side 828, 830 or 832 of the touch screen 810. Each of the camera assemblies 802, 804 and 806 may have a 2D image sensor. The camera assemblies 802-806 are shown having two optical components each for simplicity, indicating that each camera assembly 802-806 includes two virtual cameras. However, it should be understood that a camera assembly may have more or less virtual cameras. In some embodiments, the camera assembly 806 may have a light source (similar to the light source 146) that increases the illumination along the Z-axis. “Z-axis” refers to the 3-D coordinate perpendicular to X and Y coordinates along which a distance may be indicated. This may improve the detection of one or more touches along the Z-axis, improving the use of gestures that may change based on a distance a pointer is from the touch surface 102. Both speed of the pointer and distance from the touch surface 102 may be determined. Alternatively, one or two of the camera assemblies 802, 804 and 806 may utilize a linear sensor and/or simple optics.

Referring to the camera assembly 806, one or both of virtual cameras 834 and 836 may have a FOV that is larger than the FOV associated with the virtual cameras of the camera assemblies 802 and 804. For example, each of virtual cameras 834 and 836 may have a FOV of up to 180 degrees. As discussed previously, the virtual cameras of the camera assembly mounted proximate a corner of the display screen, such as shown in FIG. 3, may have fields of view of approximately ninety degrees.

Increasing the number of camera assemblies located in different areas with respect to the touch screen 810 may allow a greater number of simultaneous touches to be detected. As shown there are five simultaneous touches at locations 816, 818, 820, 822 and 824. With respect to the camera assembly 802, the touch at location 816 may at least partially obscure the touches at locations 820 and 824. With respect to the camera assembly 804, the touch at location 818 may at least partially obscure the touches at locations 820 and 822. Therefore, a separate touch at location 820 may not be detected by either of the camera assemblies 802 and 804. With the addition of the camera assembly 806, however, the touch at location 820 is detected. Similarly, with respect to the camera assembly 806, the touches at locations 816 and 818 may at least partially obscure the touches at locations 822 and 824, respectively. However, in this configuration camera assembly 802 would detect the touch at location 822 and camera assembly 804 would detect the touch at location 824.

To detect an increased number of simultaneous touches and/or to decrease potential blind spots formed by touches, one or more additional camera assemblies (not shown) may be mounted proximate at least one of the other two corners 838 and 840 or proximate the sides 828, 830 and 832 of the touch screen 810.

In some embodiments, one of the camera assemblies, such as the camera assembly 806, may be replaced by a webcam (for example, standard video camera) or other visual detecting apparatus that may operate in the visible wavelength range. For example, the color filters on some video color cameras may have an IR response if not combined with an additional IR blocking filter. Therefore, a custom optic may include an IR blocking filter in the webcam channel and still have an IR response in the light sensing channels. The webcam may be separate from or integrated with the system 800. A portion of a FOV of the webcam may be used for detecting data used to determine coordinate locations of one or more touch within the touch sensing plane 170 (and/or on the touch surface 102) and/or Z-axis detection while still providing remote viewing capability, such as video image data of the users of the system 800 and possibly the surrounding area. By way of example only, a split-field optic may be used wherein one or more portions or areas of the optic of the webcam is used for touch detection and/or Z-axis detection and other portions of the optic of the webcam are used for acquiring video information. In some embodiments, the webcam may include optical components similar to those discussed previously with respect to the camera assemblies and may also include a light source. In some embodiments, the resolution and frame rate of the camera may be selected based on the resolution needed for determining multiple touches and gestures.

In some embodiments, the image sensor 130 may be used together with a simple lens, prism and/or mirror(s) to form a camera assembly detecting one FOV. In other embodiments, the image sensor 130 may be used together with more than one simple lens or prism to form a camera assembly that detects more than one FOV. Additionally, camera assemblies that use simple lens or prism may be used together in the same touch system as camera assemblies that use more complex configurations that utilize multiple optical components and/or multiple optical surfaces to detect multiple fields of view.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. This written description uses examples to disclose the invention, including the best mode, and also to enable any person skilled in the art to practice the invention, including making and using any devices or systems and performing any incorporated methods. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A touch system, comprising:
a touch sensing plane; and
a camera assembly positioned proximate the touch sensing plane, the camera assembly comprising:
an image sensor; and
at least one virtual camera comprising at least two fields of view associated with the touch sensing plane, the at least one virtual camera comprising optical components configured to direct light that is proximate the touch sensing plane along at least one light path, the optical components configured to direct and focus the light onto different areas of the image sensor.

2. The system of claim 1, further comprising a light source configured to illuminate the touch sensing plane.

3. The system of claim 1, wherein at least one of the optical components comprises at least one of a refractive surface and a reflective surface.

4. The system of claim 1, further comprising a touch surface, the touch sensing plane being positioned proximate to the touch surface.

5. The system of claim 1, wherein the image sensor comprises a two-dimensional image sensor, wherein the two-dimensional image sensor comprises a sensor surface having a plurality of sensing lines, and wherein at least one of the optical components is configured to direct and focus the light from the at least one light path onto one of one sensing line or a set of neighboring sensing lines.

6. The system of claim 1, wherein the image sensor comprises a two-dimensional image sensor, wherein the two-dimensional image sensor comprises a sensor surface having a plurality of sensing lines, wherein the at least one light path further comprises at least two light paths, wherein the optical components are further configured to direct and focus the light from the at least two lights paths onto any of different sensing lines and different sets of neighboring sensing lines on the two-dimensional image sensor.

7. The system of claim 1, wherein the at least one virtual camera further comprises four virtual cameras, the four virtual cameras detecting at least one corresponding field of view associated with the touch sensing plane.

8. The system of claim 1, further comprising:
a light source configured to illuminate the touch sensing plane; and
a reflector mounted proximate at least one side of the touch sensing plane and configured to reflect the light from the light source towards the camera assembly.

9. The system of claim 1, wherein the at least one virtual camera comprises at least two virtual cameras, wherein the optical components of one of the at least two virtual cameras are located proximate one side of the touch sensing plane and the optical components of another one of the at least two virtual cameras are located proximate a different side of the touch sensing plane.

10. The system of claim 1, further comprising a processor module configured to determine coordinate locations of one touch or simultaneous touches within the touch sensing plane based on light levels associated with the light focused onto the different areas of the image sensor.

11. The system of claim 1, wherein the camera assembly is positioned proximate a corner of the touch sensing plane, the system further comprising another camera assembly positioned proximate one of a side or a different corner of the touch sensing plane.

12. The system of claim 11, the system further comprising at least one additional camera assembly positioned proximate another corner of the touch sensing plane or positioned proximate another side of the touch sensing plane.

13. The system of claim 1, wherein the camera assembly is positioned proximate a corner of the touch sensing plane, the system further comprising a camera positioned proximate another corner of the touch sensing plane or positioned proximate a side of the touch sensing plane, wherein the camera is configured to acquire at least video image data and data configured to be used in determining coordinate locations of one touch or simultaneous touches and Z-axis data associated with the one touch or the simultaneous touches.

14. The system of claim 1, wherein the image sensor is one of a linear sensor or a two-dimensional image sensor.

15. A touch system, comprising:
a touch sensing plane; and
a camera assembly positioned proximate the touch sensing plane, the camera assembly comprising an image sensor configured to detect light levels associated with light within the touch sensing plane, the light levels being configured to be used in determining coordinate locations in at least two dimensions of one touch or simultaneous touches within the touch sensing plane.

16. The system of claim 15, further comprising at least one additional camera assembly positioned proximate the touch sensing plane, the at least one additional camera assembly comprising another image sensor configured to detect light levels associated with light within the touch sensing plane, the light levels being used to further determine the coordinate locations in at least two dimensions of the one touch or the simultaneous touches within the touch sensing plane.

17. The system of claim 15, further comprising a processor module configured to determine the coordinate locations of the one touch or the simultaneous touches within the touch sensing plane.

18. The system of claim 15, wherein the image sensor comprises one of a linear sensor and a two-dimensional image sensor.

19. The system of claim 15, the camera assembly further comprising optical components configured to direct and focus the light that is detected within a field of view comprising at least a portion of the touch sensing plane onto an area of the image sensor, the optical components further configured to direct and focus the light that is detected within another field of view comprising at least a portion of the touch sensing plane onto a different area of the image sensor.

20. A camera assembly for detecting one touch or simultaneous touches, comprising:
an image sensor; and
optical components configured to direct light associated with at least two fields of view along at least one light path, the optical components configured to direct and focus the light that is associated with one of the fields of view onto one area of the image sensor and to direct and focus the light that is associated with another one of the fields of view onto a different area of the image sensor, light levels associated with the light are configured to be used in determining coordinate locations of one touch or simultaneous touches within at least one of the at least two fields of view.
